(19) United States
(12) Patent Application Publication
(10) Pub. No.: US 2023/0241682 A1
(43) Pub. Date: Aug. 3, 2023

(54) METHOD FOR PRODUCING A MOLD SEGMENT COMPONENT, MOLD SEGMENT COMPONENT, VULCANIZATION MOLD, AND PNEUMATIC VEHICLE TIRE

(71) Applicant: Continental Reifen Deutschland GmbH, Hannover (DE)

(72) Inventors: Nicholas Hoppe, Wunstorf (DE); Jürgen Dzick, Seelze (DE); Bert Voelker, Hannover (DE)

(73) Assignee: Continental Reifen Deutschland GmbH, Hannover (DE)

(21) Appl. No.: 18/002,325

(22) PCT Filed: Dec. 8, 2020
(86) PCT No.: PCT/EP2020/085032

§ 371 Date: Dec. 19, 2022

(30) Foreign Application Priority Data
Jun. 17, 2020 (DE) 10 2020 207 473.9

(51) Int. Cl. B22F 10/28; B22F 5/00

(52) U.S. Cl. CPC B22F 10/28; B22F 5/007; B33Y 10/00

(57) ABSTRACT

A method for producing a mold segment component of a vulcanizing mold for a pneumatic vehicle tire for forming at least one profile block or a region structured in a block-like manner of an altogether curved tread, with a tread outer surface, which mold segment component is built up by means of an additive process, such as selective laser melting, by layer-by-layer planar application and melting of a metal powder on a planar building plate (10) together with a bottom part (7b) and mold elements, such as lamellae (4) and/or microlamellae (11) and/or ribs and/or regions of ribs, wherein mold elements delimit or run around mutually adjacent mold area elements (12) of the bottom part (7b) which have outer surfaces (12a) forming a region of the tread outer surface.

In the additive build-up operation, the mold area elements (12) are each additively built up with a unitary planar outer surface (12a) or with two to three planar outer surfaces (12a) running in a stepped manner in relation to one another, wherein all of the outer surfaces (12a) of the mold area elements (12) run parallel to one another and, with respect to the building plate (10), are surfaces at different levels such that the mutual arrangement of the outer surfaces (12a) of the mold area elements (12) largely approximates to the curvature of the region to be formed of the tread outer surface.

The invention relates to a method for producing a mold segment component of a vulcanizing mold for a pneumatic vehicle tire for forming at least one profile block or a region structured in a block-like manner of an altogether curved tread, with a tread outer surface, which mold segment component is built up by means of an additive process, such as selective laser melting, by layer-by-layer planar application and melting of a metal powder on a planar building plate together with a bottom part and mold elements, such as lamellae and/or microlamellae and/or ribs and/or regions of ribs, wherein mold elements delimit or run around mutually adjacent mold area elements forming a region of the tread outer surface.

The invention also relates to a mold segment component of a vulcanizing mold for a pneumatic vehicle tire for forming at least one profile block or a region structured in a block-like manner of an altogether curved tread, with a tread outer surface, which mold segment component is built up by means of an additive process, such as selective laser melting, by layer-by-layer planar application and melting of a metal powder on a planar building plate together with a bottom part and mold elements, such as lamellae and/or microlamellae and/or ribs and/or regions of ribs, wherein mold elements delimit or run around mutually adjacent mold area elements forming a region of the tread outer surface.

The invention also relates to a pneumatic vehicle tire with a profiled, altogether curved tread, which is divided into profile blocks by grooves and/or is structured in a block-like manner, wherein profile blocks and/or block-like structures are present which are provided with sipes and/or microsipes passing through them, wherein positive area elements are formed between sipes or microsipes or between sipes and microsipes or between sipes, microsipes and grooves.

Pneumatic vehicle tires are vulcanized in heating presses, in which green tires are inserted into a vulcanizing mold and vulcanized under the action of pressure and heat. The tread of the tire is shaped and heated here by means of a mold segment ring consisting of a plurality of mold segments, the tread profile also being formed since the mold segments are provided with mold elements, such as ribs and lamellae, on their mold sides facing the mold cavity. Traditionally, mold segment rings are produced from steel alloys or aluminum alloys by casting processes with subsequent machining or by machining only.

It is also known to produce mold segment components or mold segments by means of an additive manufacturing process, in particular by selective laser melting. By way of example, EP 2 379 315 B1 discloses the one-part production of a lining layer, 0.25 mm to 3.00 mm thick, for mold segments together with the mold elements forming the tread profiling by laser sintering. EP 2 399 695 A1 discloses the production of complete mold segments with the elements forming the profiling of the tread by selective laser melting. DE 10 2018 202 603 A1 discloses a mold segment component which includes the negative profile of the tread and which is produced by means of a generative manufacturing process, for example by means of selective laser melting. The mold segment component is connected in a materially bonded manner to a carrier element serving as segment spine, such that a hybrid mold segment is obtained in this way.

When additively building up mold segments or mold segment components, the mold surface area which forms the outer surface (positive surface area) of the tread during the vulcanization is built up according to the intended and required curvature of the tread of the pneumatic vehicle tire. Since the additive build-up operation involves layer-by-layer application of metal powder and subsequent melting of the metal powder, this curvature is formed by corresponding offset of the individual successively applied layers. As a result, a multiplicity of tiny steps are formed on the inner surface or on the mold area elements. Subsequent machining for smoothing purposes is difficult, especially between lamellae or microlamellae where there are small mold area elements, and is therefore omitted. If a tire is vulcanized in such a vulcanizing mold, the tread has an irregularly structured and less visually appealing positive area.

The invention addresses the problem of avoiding such step formations, in order to ensure an almost perfect outer surface of the treads of the vulcanized tires, in particular including the regions of the surface area at sipes, microsipes and between sipes, microsipes and grooves.

With respect to the method, the stated problem is solved according to the invention in that the mold area elements are additively built up in each case as a unitary planar surface area or from a plurality of planar surface areas running in a stepped manner in relation to one another, with a difference in level of at least 100 μm, wherein all of the mold area elements or their surface areas run parallel to one another and, with respect to the building plate, are areas at different levels such that their mutual arrangement largely approximates to the curvature of the region to be formed of the tread outer surface.

The mold segment component according to the invention is characterized in that mold area elements are in each case unitary planar surface areas or consist of a plurality of planar surface areas running in a stepped manner in relation to one another, with a difference in level of at least 100 μm, wherein all of the mold area elements or their surface areas run parallel to one another and, with respect to the building plate, are areas at different levels such that their mutual arrangement largely approximates to the curvature of the region to be formed of the tread outer surface.

As a result of the invention, mold area elements which do not require subsequent machining and which form qualitatively perfect positive surface areas on the vulcanized tires are formed. Since the orientation of the very small mold area elements which are oriented parallel to one another approximates to the curvature of the positive area region to be formed, a tire vulcanized in a vulcanizing mold comprising mold segments which, on the inside of the mold, are made up of mold segment components according to the invention has a very visually appealing positive area overall.

Preferably, the mold segment component is additively built up with lamellae and/or microlamellae running parallel to one another. It is particularly advantageous in this embodiment if mold area elements with a plurality of planar surface areas running in a stepped manner in relation to one another with side surfaces bringing about the difference in level are additively built up in such a way that the side surfaces run parallel to the course of the lamellae and/or microlamellae. In a preferred refinement, mold area elements composed of two or three such surface areas are provided.

The curvature of a tread of a pneumatic vehicle tire changes mostly over the tread width, is usually smaller in the middle region of the tread and a little greater at the tire shoulders. It is therefore advantageous in particular on the tire shoulder side if the mold segment components forming these regions are those in which the mold area elements are built up so as to consist of, for example, two or three, that is to say a plurality of, planar surface areas running in a stepped manner in relation to one another. Mold area elements with a plurality of surface areas running in a stepped manner in relation to one another form positive area elements with step edges in the tread of the tire, which are advantageous for winter performance, grip on snow and ice. The interlock effect which can be achieved on snow and ice is particularly effective especially if the surface areas running in a stepped manner in relation to one another are built up on mold segment components forming the tread in such a way that the surface areas have widths which differ from one another by at most +/−30%.

Preferably, an insert, as mold segment component, is additively built up with mold elements, such as lamellae, microlamellae and/or ribs and/or partial regions of ribs, possibly with peripheral frame parts and with the bottom plate.

The mold segment component is therefore in particular an insert forming at least one profile block and having the bottom part, mold elements and possibly peripheral frame parts, which are ribs forming grooves or ribs forming parts of grooves.

According to a further preferred embodiment of the method, structures in the form of elevations and/or depressions, in particular having a height or depth, respectively, corresponding to the layer thickness of the additive process, are superficially printed on the mold area elements. Mold area elements printed in this way imprint microstructures on the tread of the vulcanized tire which ensure particularly good ice and snow grip properties especially in the case of a new tire. In this regard, the formation of surface structures of regular embodiment, such as structures designed in a network-like manner, is particularly advantageous. However, structures which are printed in the form of visual elements, geometric patterns, letters, and the like, may also improve grip on snow and ice.

The invention also relates to a vulcanizing mold for pneumatic vehicle tires, comprising mold segments which contain mold segment components as claimed in one or more of claims 8 to 11.

In the case of the pneumatic vehicle tire according to the invention, positive area elements in a profile block or in a block-like structure are either each a unitary planar surface area or each consist of a plurality of surface areas running in a stepped manner in relation to one another, with a difference in level of at least 100 μm, wherein all of the surface areas of a profile block or a block-like structure run parallel to one another and are at different levels so as to follow the curvature of the tread.

Such profile positive area elements bring about an additional structuring of the tread with edges, in particular with edges at which an increased edge pressure acts when the tire is rolling on the ground surface. This increased edge pressure is particularly advantageous for winter performance, in particular the grip of the tire on snow and ice.

Preferably, the sipes and/or microsipes in the profile blocks or block-like structures extend parallel to one another. It is also advantageous in this refinement if, in the case of positive area elements composed of a plurality of surface areas at different levels, these are delimited by at least one edge which runs parallel to the sipes and/or microsipes so as to follow the course thereof.

Further features, advantages and details of the invention will now be described in more detail on the basis of the schematic drawing, which illustrates exemplary embodiments. In the drawing:

FIG. 1 shows a view of a mold segment part of a tire vulcanizing mold composed of a base part and with inserted inserts,

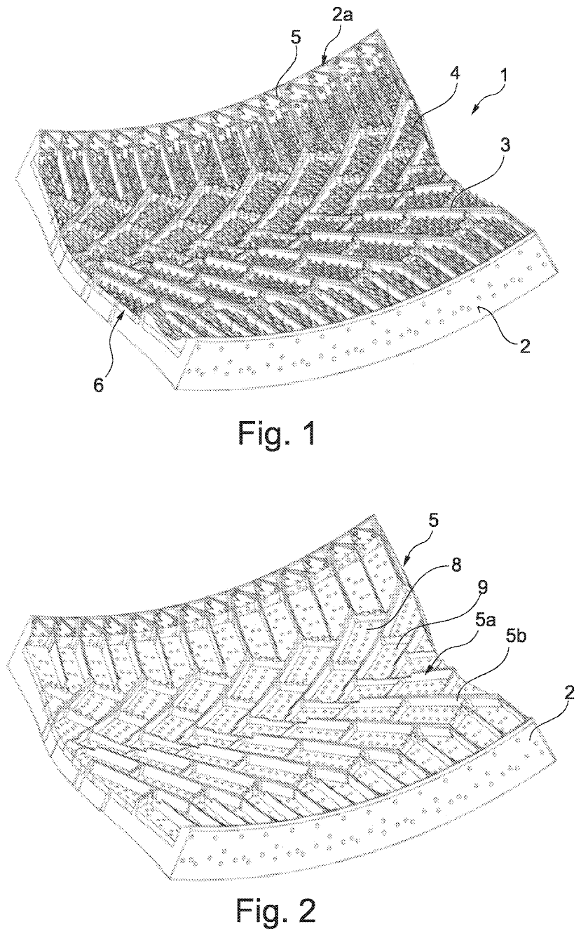

FIG. 2 shows a view of a base part,

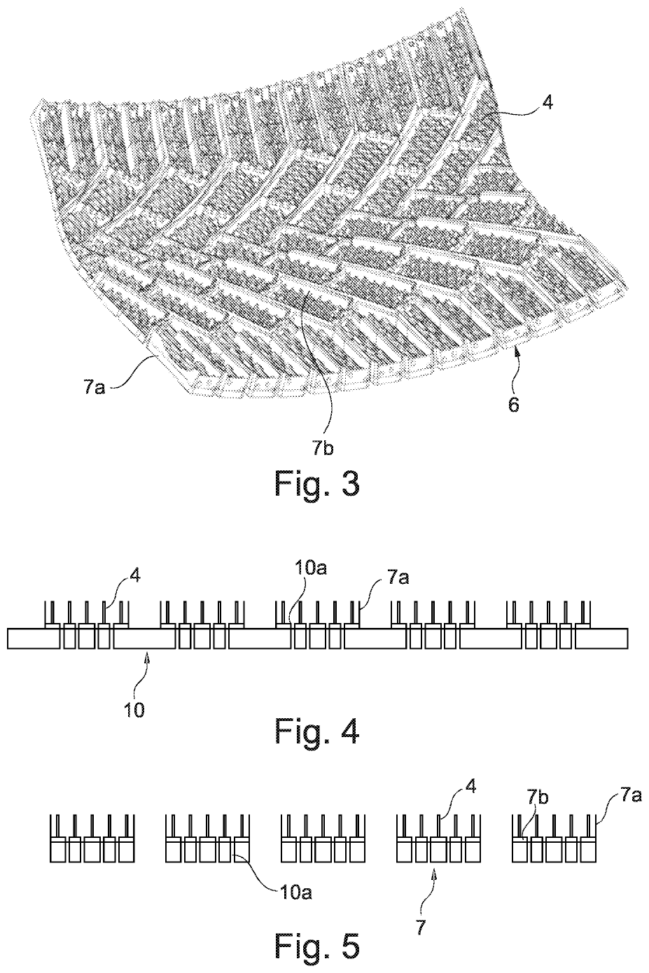

FIG. 3 shows a view of the associated inserts,

FIG. 4 shows a schematic view of a building plate with built-up inserts,

FIG. 5 shows a schematic view of inserts cut out of the building plate,

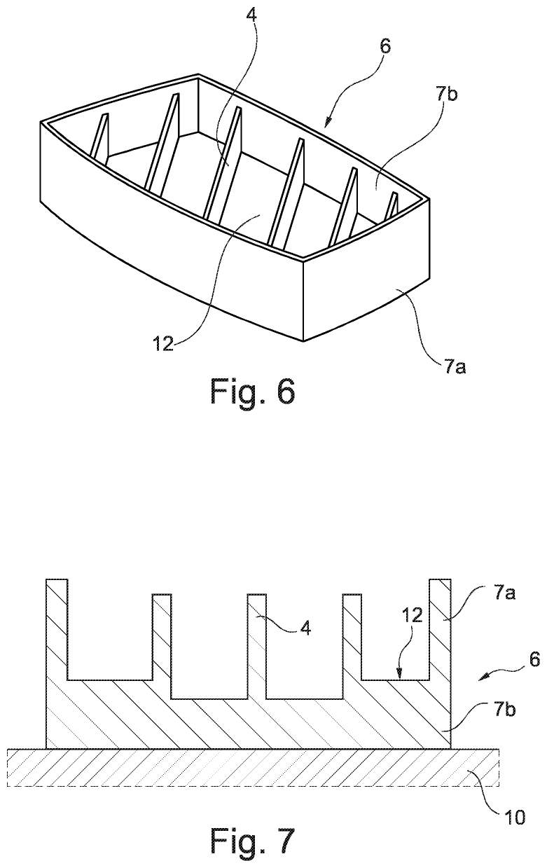

FIG. 6 shows a schematic view of an individual insert,

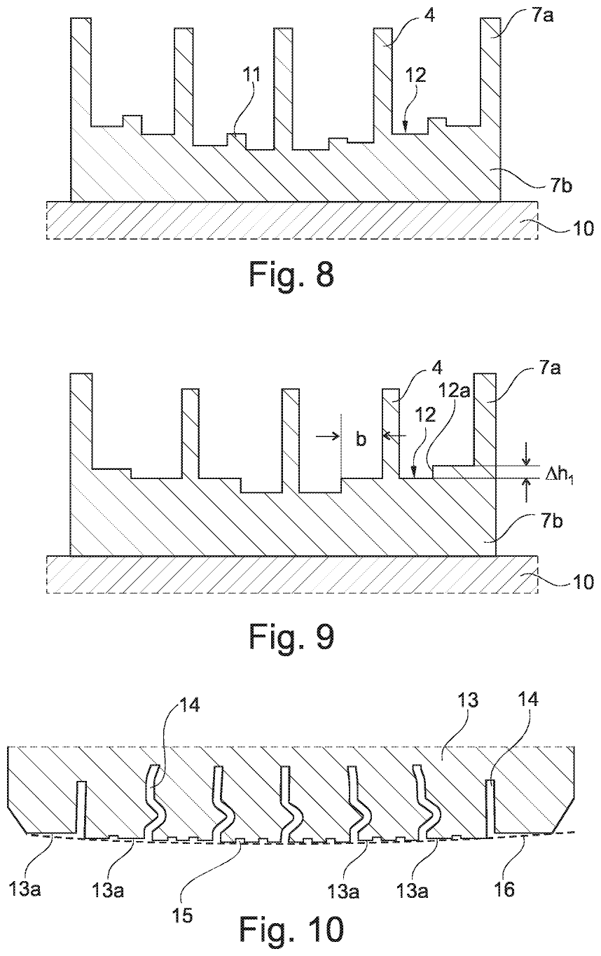

FIG. 7, FIG. 8 and FIG. 9 show sectional illustrations of inserts with different embodiments of the invention, and

FIG. 10 shows a profile block of a tread of a pneumatic vehicle tire in section.

In the description below, radial direction is understood to mean the direction of a perpendicular to the mold surface area forming the tread outer surface, and axial direction is understood to mean a direction parallel to the axis of rotation of the tire to be vulcanized.

FIG. 1 shows a view of a mold segment part 1 of a mold segment of a segment ring of a tire vulcanizing mold, in particular for tires for passenger vehicles, vans or light trucks, wherein in particular the inner side—the side facing the mold cavity—can be seen. The segment ring is the part of the vulcanizing mold which forms the tread of the tire together with its profiling during the vulcanization of the tire. Conventional segment rings are each made up, for example, of seven to fourteen mold segments, each of which has a mold segment spine opposite the inner side, by means of which the mold segments are arranged in a manner known per se on a segment shoe of the tire vulcanizing mold.

In order to form the profiling of the tread of the tire to be vulcanized, the mold segment part 1 has mold elements (these are in particular ribs 3, lamellae 4 and possibly microlamellae 11), wherein the ribs 3 in the illustrated embodiment are formed at least partially by a rib skeleton 5 and partially by inserts 6, as will be described in more detail.

Lamellae 4 usually have a width in the order of magnitude of 0.40 mm to 1.00 mm, their height may vary and correspond at least in certain portions to the rib height. Microlamellae 11, which usually form narrow and shallow sipes, have a width and height of approximately 0.20 mm to 0.30 mm.

The rear sides of the mold segment parts 1 are, for example, simple cylindrical surfaces, such that the mold segment parts 1 can be attached to the segment shoe of the vulcanizing mold by means of appropriately designed adapters. In an alternative embodiment, the mold segment parts 1 themselves are already designed as an interface to the container of the vulcanizing mold.

The base part 2 of the mold segment part 1 consists of a metallic material, in particular of a steel alloy or of an aluminum alloy. In the embodiment shown, the base part 2 is a milled part with milled shoulder decoration ribs 2a on its lateral peripheral regions and the milled rib skeleton 5 (FIG. 2). The rib skeleton 5 has ribs 5a with rib flanks 5b, the arrangement of which and the course of which correspond to the arrangement and the course of ribs 3. The ribs 5a of the rib skeleton 5 are narrower than the ribs 3 forming grooves, the rib flanks 5b are missing flank portions which, as will be described, are supplemented by frame parts 7a of the inserts 6. According to a preferred embodiment, the rib flanks 5b are planar surfaces which are oriented in the radial direction. Fundamentally, the ribs 5a together with their rib flanks 5b are milled in such a way that the inserts 6 can be inserted from above in a flush manner. The level of the pointed regions of the ribs 5a corresponds to that of the ribs 3 forming grooves. However, the ribs 5a have a greater height than the ribs 3, since they, on the shoulder side together with the shoulder decoration ribs 2a, enclose deeper milled-out depressions with planar bottom surfaces 8. The depth of these depressions or the level of the bottom surfaces 8 is adapted to the thickness of bottom plates 7b of the inserts 6 in such a way that, when the inserts 6 are inserted, the inner sides of the inserts 6 forming the mold surface are at the intended mold surface level. The orientation of the bottom surfaces 8 is adapted to the desired rounding or contour of the outer side of the tread of the tire to be vulcanized.

For ventilation, the base part 2 is pierced between the bottom surfaces 8 and its rear side, either a respectively larger number of holes 9 being created per bottom surface 8 or only one or two holes 9 being created for ventilation, and a type of channel network of flat depressions, connected to the hole 9 or the holes 9, being milled on the respective bottom surface 8.

The inserts 6 are built up from a metal powder in a larger number on a building plate 10 by an additive process, in particular by selective laser melting (FIG. 4). The building plate 10 is a planar plate, and, in a preferred embodiment, the thickness of the building plate 10 also determines the required depth of the mentioned depressions in the base part 2. The building plate 10 is first also provided with holes 10a corresponding to the arrangement of the holes 9 in the base part 2. Channel networks, which correspond to the milled channel networks that may be provided on the bottom surfaces 8, may be formed, but this is not absolutely necessary, since the channel networks milled on the bottom surfaces 8 usually already ensure good ventilation.

The building plate 10 is aligned and positioned accordingly in a 3D printer, and the holes 10a created are filled with metal powder or the like flush with the upper side of the building plate 10. The individual inserts 6 are then built up layer by layer in their intended designs, together with the intended lamellae 4 (FIG. 4), any additional microlamellae 11 (FIG. 8), other surface structures, optionally letters, treadwear indications, and the like. Ventilation holes are left free at the positions of the holes 10a in the building plate 10. The inserts 6 (FIG. 6) are also built up with the intended lamellae 4, possibly with microlamellae 11, the mentioned peripheral frame parts 7a, the bottom plate 7b, in such a way that, when the inserts 6 are inserted at their intended positions on the base part 2, the ribs 5a of the rib skeleton 5 are supplemented to form complete ribs 3 forming grooves. Depending on the actual design of the tread profile with grooves, the inserts 6 may also have frame parts 7a only on two or three sides and/or be designed in such a way that they form, together with the rib skeleton 5, larger profile blocks, more than one profile block or other block-like structures in the tread. The inserts 6 may also contain mold elements which form ribs, apart from the rib skeleton.

In an alternative embodiment, the base part 2 of the mold segment part 1 does not have a rib skeleton but has an inner surface on which inserts are positioned and fastened, for example screwed, which have been additively built up together with mold elements which form the intended ribs. The ribs may be built up as peripheral frame parts of the inserts or be formed within the inserts, such that it is possible to use inserts without peripheral frame parts or inserts that are only partially provided with peripheral frame parts.

On the upper side of the building plate 10, the bottom plates 7b of each insert 6 are built up with planar mold area elements 12 running in a stepped and parallel manner in relation to another, the outermost layer of which is in each case a molten metal powder layer with a planar outer surface.

FIG. 7 shows one exemplary embodiment of an insert 6 with three additively built-up lamellae 4 running parallel to one another between two frame parts 7a. An additively built-up planar mold area element 12, which runs parallel to the surface of the building plate 10, is located in each case between the lamellae 4 and between the two outer lamellae 4 and the frame parts 7a. The mold area elements 12 between the outer lamellae 4 and the frame parts 7a have corresponding heights and, with respect to the building plate 10, are at a higher level than the two mold area elements 12 between the lamellae 4 located further inward, the levels of which likewise correspond.

Each insert 6 occupies a specific position on the mold segment part 1 or is intended for a specific position. In each position, the respective insert 6 is intended to form the outer contour or curvature, provided at this location, of the tread outer surface in an optimal manner. The mold area elements 12 are therefore built up with a number of layers that is adapted in this regard to the layer thicknesses used in the additive process in such a way that the mold area elements 12 have levels which are adapted to the curvature of the relevant tread region in an optimal manner.

FIG. 8 shows one exemplary embodiment of an insert 6 with three lamellae 4, a respective microlamella 11 having been additively built up in each case between the three lamellae 4 and the outer lamellae 4 and the frame parts 7a. The microlamellae 11 and the lamellae 4 in particular run parallel to one another, and the microlamellae 11 centrally between the lamellae 4 and the frame parts 7a. A respective unitary planar mold area element 12 is additively formed both between the microlamellae 11 and the lamellae 4 and between the microlamellae 11 and the frame parts 7a. The mold area elements run in a stepped manner—at different levels—and parallel to one another and to the lamellae 4 and microlamellae 11 in such a way that their levels are optimally adapted to the curvature of the tread region to be formed.

FIG. 9 shows one embodiment of an insert 6 with three lamellae 4 running parallel to one another. The insert 6 is intended for a position on the mold segment part 1 at which the outer contour of the tread part to be formed at this location requires a height difference Δh₁ between the base of adjacent lamellae 4 and/or the outer lamellae 4 and the frame parts 7a of at least 100 μm. Between the mutually positioned lamellae 4 and/or between the outer lamellae 4 and the frame parts 7a, the mold area element 12 is additively built up in each case from two planar surface areas which run parallel to one another and are at different levels. All of these surface areas in the insert 6 run parallel to one another. In the example shown, the two surface areas which adjoin the middle lamella 4 on both sides are at the lowest level with respect to the building plate 10, and the outermost surface areas on the respectively outermost mold area elements 12 are at the relatively highest level. Instead of two surface areas, it is also possible to form three or more surface areas with different levels. A respective perpendicular side surface 12a, which runs parallel to the lamellae 4, runs between the two surface areas in each mold area element 12. The widths b of the surface areas preferably substantially correspond, but may differ from one another preferably by at most ±30%, depending on the curvature to be reproduced and the distances between the lamellae 4 or the lamellae 4 and the frame parts 7a.

The lamellae 4 and the microlamellae 11 may be of zigzag-shape or wavy form, and/or may have any other desired, in particular three-dimensional structuring. The lamellae 4 and microlamellae 11 may also be formed with varying heights.

The planar mold area elements 12 or the surface areas thereof may also additionally be printed in high resolution in any desired manner and obtain different surface structures in this way. Such structures are tiny elevations and/or depressions, which have a height or depth, respectively, of for example 30 μm, corresponding to the layer thickness of a metal powder layer, in particular are visual elements, geometric patterns or letters or are structures which superficially form structures in the tread that, for example, bring about good ice or snow grip properties of the tread in the case of a new, unworn tyre.

The inserts 6 together with the building plate part, on which they are directly built up, are preferably cut out of the building plate 10, for example by means of a laser beam, water jet or mechanically. The fitting surfaces are subsequently machined if necessary. The bottoms of such inserts 6 therefore each consist of the building plate part and the additively built-up bottom plate 7b with the mold area elements 12. In an alternative embodiment, the inserts 6 are separated along the upper side of the building plate 10, for example are cut off, the bottoms of such inserts are therefore the additively built-up bottom plates 7b. In a further alternative, prefabricated bottom plates are used in accordance with the dimensions of the inserts, and each insert is built up on a separate bottom plate.

The finished inserts 6 are then fastened at their positions on the base part 2. A fixed connection of the inserts 6 is effected, for example, by shrinking, by heating the base part 2 prior to insertion. As an alternative, the inserts 6 may be connected to the base part 2 by screwing or welding.

The additive building up of the inserts takes place automatically with software control, as does the milling work on the base parts 2. Due to the stepped transitions, the algorithm on which software control is based has to meet particular requirements, in order to ensure the most optimal configuration on the tire to achieve the most optimal performance.

FIG. 10 schematically shows a section through a profile block 13 of a tread of a pneumatic vehicle tire, sipes 14 and microsipes 15 having been formed in the profile block 13. The section is, by way of example, a section in the circumferential direction of the tread, such that the sipes 14 and the microsipes 15, which preferably all extend parallel to one another, extend in the axial direction. Along the outer surface of the profile block 13 that comes into contact with the ground surface during rolling of the pneumatic vehicle tire, an envelope 16 is additionally indicated by a dashed line, said envelope represents the outer contour that would be produced during vulcanization of the tire in a conventional tire heating press. According to the invention, the profile block 13 has an outer surface composed of positive area elements 13a which all run parallel to one another, but the mutual arrangement of which is adapted to the course of the envelopes 16 and the curvature thereof.

List of reference signs

| | |
|---|---|
| 1 | Mold segment part |
| 2 | Base part |
| 2a | Shoulder decoration rib |
| 3 | Rib |
| 4 | Lamella |
| 5 | Rib skeleton |
| 5a | Rib |
| 5b | Rib flank |
| 6 | Insert |
| 7a | Frame part |
| 7b | Bottom plate |
| 8 | Bottom surface |
| 9 | Hole |
| 10 | Building plate |
| 10a | Hole |
| 11 | Microlamella |
| 12 | Mold area element |
| 12a | Side surface |
| 13 | Profile block |
| 13a | Positive area element |
| 14 | Sipe |
| 15 | Microsipe |
| 16 | Envelope |
| b | Width |

1.-15. (canceled)

16. A method for producing a mold segment component of a vulcanizing mold, the method comprising:
building the mold component using an additive process;
melting a metal powder on a planar building plate (10) together with a bottom part (7b) and mold elements, the mold elements (4, 11) delimit adjacent mold area elements (12) and form a region of a tread outer surface;
additively building up the mold elements in each case as a unitary planar surface area or from a plurality of surface areas (12a) running in a stepped manner in relation to one another with a difference in level of at least 100 μm, wherein all of the mold area elements and their surface areas run parallel to one another with respect to the building plate and the surface areas are at different levels and their mutual arrangement approximates to a curvature region for a tread outer surface of a pneumatic vehicle tire.

17. The method of claim 16, wherein the additive process comprises selective laser melting layer-by-layer.

18. The method of claim 16, wherein the additive process comprises melting a metal power on or over a metal building plate.

19. The method of claim 16, wherein the mold elements comprise one or more of lamellae (4), microlamellae (11), ribs and/or regions of ribs.

20. The method of claim 16, further comprising producing the mold segments with lamellae and/or microlamellae extending parallel to one another and with side surfaces bringing about the difference in level are additively built up so that the side surfaces run parallel to the course of the lamellae and/or the microlamellae.

21. The method of claim 16, wherein the mold area elements (12) are additively built up from a plurality of planar surface areas running in a stepped manner in relation to one another in such a way that the widths (b) of their surface areas differ from one another by at most ±30%.

22. The method of claim 16, further comprising additively building up mold elements with peripheral frame parts (7b) to build an insert as a mold segment component.

23. The method of claim 16, wherein structures in the form of elevations and/or depressions are superficially printed on mold area elements.

24. The method of claim 23, wherein the superficial structures printed are visual elements, geometric patterns, and letters.

25. The method of claim 23, wherein the superficial structures printed are uniformly arranged structures in a network-like manner.

26. A method of forming a mold segment component of a vulcanizing mold for a pneumatic vehicle tire, the method comprising:
building a plurality of planar surface areas running in a stepped relation to one another with a difference in level of at least 100 μm; and
forming mold area elements (12) having a mutual arrangement that approximates to a curvature of a region to be formed of a tread outer surface of the tire.

27. The method of claim 26, wherein the mold area elements (12) have a plurality of planar surface areas (12a) running in a stepped manner in relation to one another and having side surfaces which run parallel to lamellae and/or microlamellae.

28. The method of claim 26, further comprising:
forming at least one profile block as an insert (6) and having a bottom part, mold elements and peripheral frame parts (7b) forming grooves and ribs.

29. The method of claim 28, the profile block having sipes and/or microsipes passing through them.

30. The method of claim 26, the profile block formed having positive area elements (13a) composed of a plurality of surface areas at different levels delimited by at least one edge which runs parallel to formed sipes (14) and/or microsipes (15) so as to follow the course thereof.

31. The method of claim 26, forming positive area elements composed of a plurality of surface areas, these surface areas are at different levels so as to be stepped in an ascending or descending manner in relation to one another.
